(19) United States
(12) Patent Application Publication
(10) Pub. No.: US 2018/0027843 A1
(43) Pub. Date: Feb. 1, 2018

(54) COMPOSITION FOR DRINKING WATER AGENT AND FEED HAVING PET URINE ODOR REMOVAL FUNCTION, COMPRISING MIXTURE OF HERBAL EXTRACTS AS ACTIVE INGREDIENT

(71) Applicant: Korea Research Institute of Bioscience and Biotechnology, Daejeon (KR)

(72) Inventors: Woo Song Lee, Daejeon (KR); Hyung Jae Jeong, Daejeon (KR); Mun Chual Rho, Daejeon (KR); Young Bae Ryu, Daejeon (KR); Hyung Jun Kwon, Daejeon (KR); Su Jin Park, Daejeon (KR); Ji Young Park, Daejeon (KR)

(21) Appl. No.: 15/547,229

(22) PCT Filed: Jan. 28, 2016
(86) PCT No.: PCT/KR2016/000955

§ 371 Date: Jul. 28, 2017

(30) Foreign Application Priority Data
Jan. 28, 2015 (KR) 10-2015-0013620

(51) Int. Cl. A23K 20/10

(52) U.S. Cl. CPC A23K 20/10

(57) ABSTRACT

The present invention relates to a composition for removing an amine-based compound, comprising an oleoresin turmeric extract, a fraction thereof, or water-soluble curcumin, a licorice extract or a fraction thereof, and a salmon milt extract as an active ingredient; and a composition for feed and feed additive comprising the same. The composition of the present invention can reduce an amine-based compound such as ammonia in animal excrement that causes the odor, and thereby reduce the odor caused by the amine-based compound and provide an effect of improving a feeding environment.

### TECHNICAL FIELD

The present invention relates to a composition for removing an amine-based compound, comprising an oleoresin turmeric extract, a fraction thereof, or water-soluble curcumin; a licorice extract or a fraction thereof; and a salmon milt extract as an active ingredient; and a composition for feed and feed additive comprising the same.

### BACKGROUND

With the mechanization, intensification, scale-up, and collectivization of the livestock industry, breeding techniques are rapidly increasing, and thus the production of livestock per unit area is also increasing. As a result, problems related to various odor-inducing gases, such as ammonia gas and the like, generated by microorganisms propagating from the excrement of livestock are increasing. These odor-inducing gases can cause various diseases in humans. However, the currently available odor-reducing agents are not capable of fundamentally removing the substances that induce the odor of excrement, and thus there is a need for a new odor-reducing agent.

Meanwhile, due to an increase in demand for pets or the like according to the sudden rise in households with one or two members, the percentage of households owning dogs and cats were 16.0% and 3.4%, respectively, in 2012. Accordingly, the costs of pets also increase, and as a result, the size of the domestic pet market including pet products reached 1,140 billion won in 2013, 1,810 billion won in 2014, and it is expected to reach about 6 trillion won in 2020. In an online open market, the sales growth rate of pet products in 2012 was 65% for handmade pet treats and 49% for cat food, compared to the previous year, and it is gradually increasing. In particular, pets have a unique odor generated from urine, and thus there is an increasing demand for litter trays, litter pads, deodorant, sand for litter treatment, and the like for reducing the odor.

Accordingly, a pet odor-reducing beverage using natural materials such as chitosan, pine leaf extract, ascorbic acid, elm tree, birch extract, and the like (Korean Patent Laid-Open Publication No. 2013-0035060), and a beverage for removing the odor of pet excrement containing chitosan, xylitol, and vitamin C (Korean Patent Laid-Open Publication No. 2004-0092051) have been reported. Korean Patent No. 532163 discloses an antibacterial deodorant composition including chitosan. However, the demand for odor-reducing agents that effectively remove the odor of pet urine has not yet been met.

### DISCLOSURE

### Technical Problem

The present inventors have made extensive efforts to develop a method for reducing the odor of pet excrement, and as a result, they found that the odor of animal excrement, especially that of pets, can be effectively removed by a treatment with a mixture of an oleoresin turmeric extract or water-soluble curcumin, a licorice extract, and a salmon milt extract, thereby completing the present invention.

### Technical Solution

It is a principal object of the present invention to provide a composition for removing an amine-based compound including an oleoresin turmeric extract, a fraction thereof, or water-soluble curcumin; a licorice extract or a fraction thereof; and a salmon milt extract as an active ingredient.

It is another object of the present invention to provide a feed composition including the composition for removing an amine-based compound.

It is still another object of the present invention to provide a method for removing the odor of animal excrement, including administering the feed composition to an animal except humans.

It is a further object of the present invention to provide a feed additive composition including the composition for removing an amine-based compound.

It is a still further object of the present invention to provide a quasi-drug composition including the composition for removing an amine-based compound.

### Advantageous Effects

The present invention can reduce the odor caused by an amine-based compound by reacting with the amine-based compound which causes the odor, such as ammonia in animal excrement, and removing the same.

Thereby, the breeding environment can be improved, and the risk of diseases which can be caused by the amine-based compound can be reduced.

### BRIEF DESCRIPTION OF DRAWINGS

FIG. 1 shows the result of an experiment on a deodorizing effect of oleoresin turmeric extract (KW-100), licorice extract (KC-100), and prototype-1 (cocktail preparation, KW-100/KC-100).

FIG. 2A-B shows the result of an experiment on acute toxicity on animal tissues according to administration of prototype-2 (KW-100/KC-100/salmon milt extract) ((a): control group, (b): experimental group (oral administration), (c): experimental group (intraperitoneal administration)).

FIG. 3 shows the changes in ammonia level in animal excrement according to administration of KW-100, prototype-1 (KW-100/KC-100), and prototype-2 (KW-100/KC-100/salmon milt extract).

### DETAILED DESCRIPTION OF THE EMBODIMENTS

In one aspect for achieving the objects above, the present invention provides a composition for removing an amine-based compound including an oleoresin turmeric extract, a fraction thereof, or water-soluble curcumin, a licorice extract or a fraction thereof, and a salmon milt extract as an active ingredient.

The oleoresin turmeric (Curcuma longa) is a herbaceous perennial plant belonging to the Zingiberaceae family and Curcuma genus, which differs from turmeric in the color of flowers. In the present invention, oleoresin turmeric can be commercially available, or collected or cultivated in nature.

The licorice (Glycyrrhiza uralensis) is a herbaceous perennial plant belonging to the Fabaceae family, and it grows naturally or is cultivated in northern China, Siberia, southern Italy, Manchuria, Mongolia, and the like. In the present invention, licorice can be commercially available, or collected or cultivated in nature. The licorice is known to alleviate oxidative damage to the kidneys and have an effect of protecting hepatocytes damaged by cadmium. However, its effects of removing an amine-based compound and the odor of animal excrement resulting therefrom are not known.

The curcumin can be commercially available, or collected or cultivated in nature. In one example, it may be isolated from the oleoresin turmeric extract, or may be water-soluble curcumin. The water-soluble curcumin may be prepared by a method commonly used in the art in order to solubilize curcumin which is water-insoluble. For example, it may refer to nano-sized curcumin.

The salmon milt extract refers to an extract derived from salmon milt (testes). For example, it may be an extract obtained by treating an acidic aqueous solution or an enzyme to the salmon milt, and may refer to an extract containing nucleic acids in high purity. The extract may contain 0.1% to 99% by weight of nucleic acids (DNA or RNA) based on the weight of the extract. The salmon milt extract is not particularly limited as long as it is used in the art as food or feed additives. The salmon milt is rich in nucleic acids and is used as a material for various functional food and cosmetics. For example, Japanese Patent No. 3,975,448 provides a health food for preventing a menopausal disorder including nucleic acids obtained from salmon milt, and Korean Patent Laid-Open Publication No. 2012-0063646 discloses a method for producing a functional liquid for cosmetics using salmon testes. However, the effect of the salmon milt extract on the removal of an amine compound is not known.

The method for obtaining the oleoresin turmeric extract or licorice extract is not particularly limited as long as it can obtain an extract having the effect of removing the amine compound, but may refer to resultant products of a liquid component obtained by immersing each of oleoresin turmeric or licorice in various solvents followed by extracting at room temperature or under a heating condition for a predetermined period of time, or of a solid component obtained by removing the solvent from the liquid component, etc. Further, in addition to the resultant products mentioned above, it can be comprehensively interpreted to include all of a diluted solution of the resultant product, a concentrate thereof, a crude or purified form thereof, a purified form thereof, and the like.

Specifically, the oleoresin turmeric extract or licorice extract may be those in which a dried material, a processed material, or a pulverized material of each of oleoresin turmeric or licorice is eluted with a polar solvent, such as water, a lower alcohol having 1 to 4 carbon atoms (C₁-C₄) including methanol, ethanol, and the like, the volume of which is about 5 to 30 times, specifically about 10 to 20 times the dry weight, or with a mixed solvent thereof having a mixing ratio of about 1:0.1 to 1:10. In one example, the oleoresin turmeric extract may be prepared by extracting with a solvent selected from the group consisting of water, an alcohol having 1 to 4 carbon atoms, ethyl acetate, and a mixed solvent thereof. Further, the licorice extract may be prepared by extracting with a solvent selected from the group consisting of water, an alcohol having 1 to 4 carbon atoms, ethyl acetate, and a mixed solvent thereof.

The oleoresin turmeric extract or licorice extract may be extracted by using an extraction method such as hot water extraction, cold extraction, reflux condenser extraction, filtration extraction, or ultrasonic extraction under conditions where the extraction temperature is, without limitation, 20° C. to 100° C., specifically 60° C. to 100°, and the extraction time is about 1 hour to 4 days. In one example, the oleoresin turmeric extract or licorice extract may be contained in an amount of 0.01% to 100% by weight, more specifically 1% to 80% by weight, based on the total weight of the composition.

In the present invention, the fraction of oleoresin turmeric extract refers to a resultant product obtained by a fractionation method that separates a specific component or a specific component group from the oleoresin turmeric extract. In addition, in the present invention, the fraction of licorice extract refers to a resultant product obtained by a fractionation method that separates a specific component or a specific component group from the licorice extract.

The fractionation method for obtaining the fraction is not particularly limited, and may be carried out according to a method commonly used in the art. Examples thereof may include a solvent fractionation method performed by treating various solvents, an ultrafiltration fractionation method performed by passing through an ultrafiltration membrane having a specific molecular weight cut-off value, a chromatographic fractionation method performed by using various chromatographic systems (manufactured for separation based on size, charge, hydrophobicity or affinity), and a combination thereof, etc.

The type of solvent used for obtaining the fraction is not particularly limited, and any solvent known in the art can be used. Non-limiting examples of the fraction solvent include polar solvents such as water, alcohol, and the like; and non-polar solvents such as hexane, ethyl acetate, chloroform, dichloromethane, and the like. These may be used alone or in a combination of two or more. When the alcohol is used among the fraction solvents, a C₁ to C₄ alcohol may be specifically used.

The fraction of oleoresin turmeric extract or the fraction of licorice extract may be contained in an amount of 0.01% to 100% by weight, more specifically 1 to 80% by weight, based on the total weight of the composition.

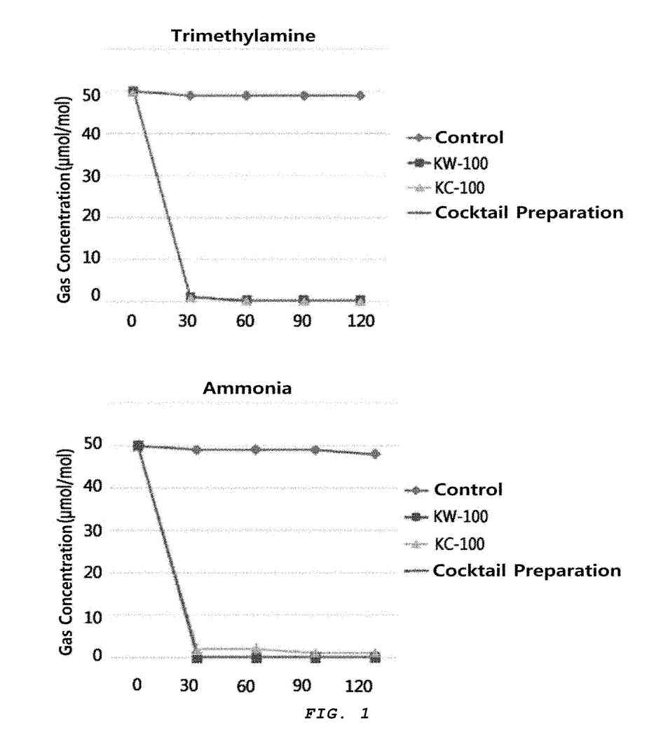

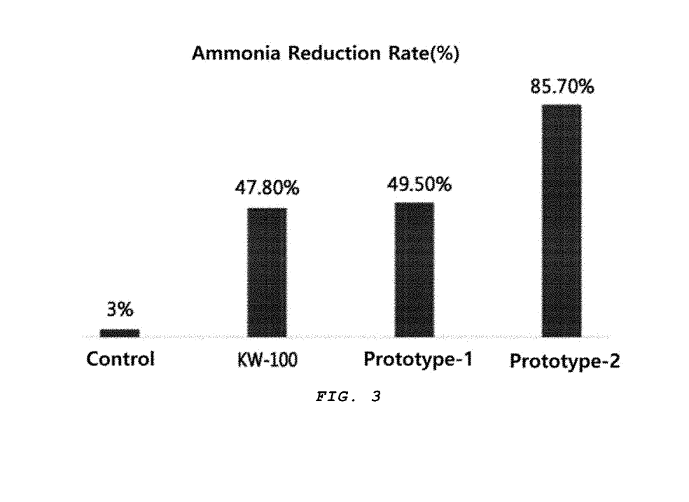

In the present invention, the amine-based compound refers to a compound containing an amine group (NH₂). In one example, the amine-based compound may be trimethylamine, ammonia, indole, or skatole, and specifically, it may be trimethylamine or ammonia. The present inventors confirmed that the composition for removing an amine-based compound of the present invention completely removed trimethylamine and ammonia, which cause an odor within 30 minutes (FIG. 1) and effectively removed ammonia in the odor component of animal excrement, and further the drinking water agent including the oleoresin turmeric extract or water-soluble curcumin, licorice extract, and salmon milt extract effectively removed ammonia, compared to the drinking water agent containing curcumin and the drinking water agent containing the oleoresin turmeric extract or water-soluble curcumin and licorice extract (FIG. 3). Thus, the composition may be a composition for removing the odor caused by an amine compound.

The oleoresin turmeric extract or water-soluble curcumin and licorice extract may be mixed in a weight ratio of 1:20 to 1:200. The oleoresin turmeric extract or water-soluble curcumin; licorice extract; and salmon milt extract may be mixed in a weight ratio of 0.5 to 5:20 to 200:0.5 to 5. Specifically, the oleoresin turmeric extract or water-soluble curcumin; licorice extract; and salmon milt extract may be mixed in a weight ratio of 1:20 to 200:0.5 to 5.

In another aspect, the present invention provides a feed composition including the composition for removing an amine-based compound.

In the present invention, the composition for removing an amine-based compound includes an oleoresin turmeric extract, a fraction thereof, or water-soluble curcumin, a licorice extract or a fraction thereof, and a salmon milt extract as an active ingredient, and the specific contents thereof are as described above.

The feed composition of the present invention may refer to any natural or artificial diet, single meal, or substance of the single meal for animals to eat, ingest, and digest or suitable for this purpose, and the feed composition may be prepared in various forms known in the art.

The type of the feed is not particularly limited, and any feed commonly used in the art can be used. Non-limiting examples of the feed include vegetable feeds such as grain, nut, food byproduct, seaweed, fiber, drug byproduct, oil, starch, oil meal and grain byproduct, and the like; animal feeds such as proteins, inorganic material, fat, mineral, single cell protein, zooplankton, or food waste, etc. They can be used alone or in a combination of two or more.

The feed composition may be a composition for removing the odor of animal excrement. The present inventors confirmed that the feed composition of the present invention has a superior effect of reducing ammonia contained in animal excrement (FIG. 3).

In one example, the feed composition may contain the composition for removing an amine-based compound in a ratio of 0.1% to 20% by weight.

In another example, the feed composition may contain the composition for removing an amine-based compound in an amount of about 1 g to 500 g, specifically 10 g to 250 g per 1 kg, based on the weight of the animal to which the composition is administered.

The feed composition may be a drinking water agent. The drinking water agent refers to an agent that can be administered in a liquid form and corresponds to feed supplements approved by the Control of Livestock and Fish Feed Act.

The feed composition of the present invention may further contain substances exhibiting various effects such as supplementing nutrition and preventing weight loss, enhancing digestion of fibers within the feed, improving milk quality, preventing reproductive disorders and improving pregnancy rate, and preventing a high-temperature stress during summer. Examples thereof include mineral formulation including sodium hydrogen carbonate (sodium bicarbonate), bentonite, magnesium oxide, complex minerals, and trace minerals such as zinc, copper, cobalt, and selenium; vitamins such as carotene, vitamin E, vitamins A, D, E, nicotinic acid, vitamin B complex; amino acid protective agents such as methionine and lysine; fatty acid protective agents such as fatty acid calcium; live bacterial cell and yeast such as probiotic (lactic acid bacteria), yeast culture, and fungus culture.

The feed composition of the present invention can be applied to a diet of a large number of animals including mammals and poultry, i.e., feed and drinking water.

In still another aspect, the present invention provides a method for removing the odor of animal excrement, including administering the feed composition to an animal.

The feed composition is as described above.

The animal may be mammals such as cows, horses, sheep, pigs, goats, camels, antelopes, dogs, cats, and the like, but is not limited thereto.

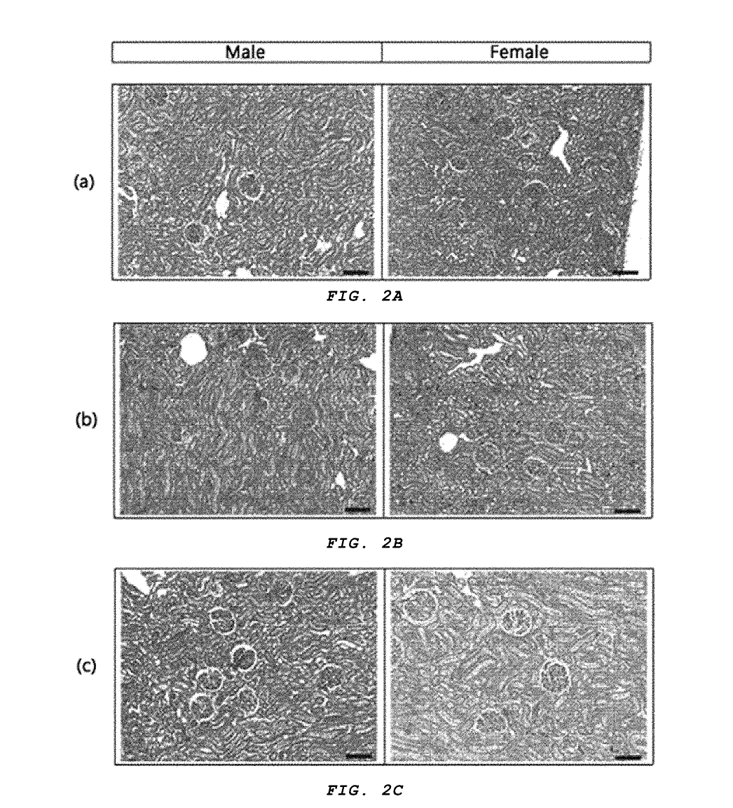

The administration refers to introducing the composition of the present invention to an animal by any appropriate method, and the administration route of the composition of the present invention may include various routes such as oral or parenteral administration as long as it can reach the target tissue. The present inventors confirmed that acute toxicity did not appear even when the feed composition of the present invention was administered orally or intraperitoneally (FIG. 2).

In a further aspect, the present invention provides a feed additive composition including the composition for removing an amine-based compound.

The feed additive composition of the present invention may be used by further mixing, in addition to the components described for the administration, at least one of organic acids such as citric acid, fumaric acid, adipic acid, and lactic acid, phosphates such as potassium phosphate, sodium phosphate, and polyphosphate, or natural antioxidants such as polyphenol, catechin, tocopherol, vitamin C, green tea extract, chitosan, and tannic acid. If necessary, other conventional additives such as buffers, bacteriostatic agents, and the like may be added. Further, it is possible to formulate into an injectable formulation, such as an aqueous solution, suspension, emulsion, and the like, capsule, granule, or tablet by additionally adding diluents, dispersants, surfactants, binding agents, and lubricants.

In addition, the feed additive composition of the present invention and the feed composition including the same can be used together with nutritional supplements, growth promoters, digestion-absorption promoters, and disease prevention agents, in addition to various auxiliaries such as amino acids, inorganic salts, vitamins, antioxidants, antifungals, microorganism preparations, and the like as auxiliary components, and the main ingredients such as vegetable protein feeds such as pulverized or crushed wheat, barley, corn, and the like, animal protein feeds such as blood meal, meat meal, fish meal, and the like, and animal fat and vegetable fat.

The feed additive for animal feed can be directly mixed with the animal feed or, apart from the feed, can be easily administered independently with other ingredients via oral formulation, injection, or a percutaneous route. The dosage range varies depending on the animal's body weight, health condition, diet, method of administration, severity of the disease, and the like. The daily dose is about 0.1 mg/g to 10 mg/g, specifically 0.05 mg/g to 1 mg/g, as it is well known in the art, and it is more preferable to administer once a day or several times a day.

The feed additive of the present invention can be added to the feed for the purpose of removing the odor of animal excrement. When the feed additive of the present invention is used as a feed additive, the feed additive may be added as it is or used together with other ingredients, and may be appropriately used according to a conventional method. The dosage form of the feed additive may be prepared into immediate release or sustained release formulations by combining with a non-toxic pharmaceutically acceptable carrier. The edible carrier may be corn starch, lactose, sucrose, and soybean flake and propylene glycol. In the case of solid carriers, they may be used as tablets, powders, and troches. In the case of liquid carriers, they may be in the form of a syrup, liquid suspension, emulsion, and solution.

The feed additive composition of the present invention may be applied to a diet of large number of animals including mammals and poultry, i.e., feed. It can be used for mammals such as pigs, cows, goats, and the like, which are important for commercial purposes, zoo animals such as elephants, camels, and the like, and livestock such as dogs and cats.

The method of mixing the animal feed including the feed additive composition of the present invention is carried out by mixing the feed additive composition in an amount of about 10 g to 500 g, more specifically 10 g to 100 g, per 1 kg based on the dry weight to the animal feed. In addition, after the feed mixture is thoroughly mixed, it may be preferably supplied as a mash, or may undergo pelleting, expansion, and extrusion via additional processes.

In a still further aspect, the present invention provides a quasi-drug composition including the composition for removing an amine-based compound.

In the present invention, the composition for removing an amine-based compound includes an oleoresin turmeric extract or a fraction thereof, a licorice extract or a fraction thereof, and a salmon milt extract as an active ingredient, and the specific contents thereof are as described above.

The term “quasi-drug” may refer to a product corresponding to any one selected from a textile product, a rubber product, or an analogue thereof used for the purpose of treatment, alleviation, handling, or prevention of human or animal diseases; a product which, not being a tool, a machine, or an analogue thereof, has minimal effects or does not have any effect on humans; and a preparation used for the purpose of disinfection, pest control, or a similar use thereof for the prevention of infectious diseases, which, among the products being used for the purpose of treatment, alleviation, handling, or prevention of human or animal diseases, excludes those which are not a tool, a machine, or a device; and which, among the products being used for the purpose of rendering a pharmacological effect on the human or animal structures and functions, excludes those which are not a tool, a machine, or a device. In addition, the quasi-drug may include external skin application and personal hygiene products. Specific examples include disinfectant cleaners, shower foams, gargles, wet tissues, detergent soaps, hand soap, or ointments, but are not limited thereto.

When the composition of the present invention is used as a quasi-drug additive, the composition may be added either alone or together with other quasi-drugs or quasi-drug components, and may be suitably used according to conventional methods. The mixing amount of the active ingredients may be appropriately determined depending on the purpose of use.

### BEST MODE

Hereinafter, the present invention will be described in more detail by way of Examples. However, these Examples are given for illustrative purposes only, and the scope of the invention is not intended to be limited by these Examples.

### Example 1. Preparation of Composition for Drinking Water Agent

20 L of 95% v/v ethanol was added to 2 kg of oleoresin turmeric (Curcuma longa), and the mixture was allowed to stand at room temperature for 7 days for extraction. The extract was filtered with a filter paper to obtain a liquid component, which was then concentrated and dried to prepare 210 g of an ethanol extract of oleoresin turmeric. 20 L of 95% v/v ethanol was added to 3 kg of licorice (Glycyrrhiza uralensis), and the mixture was allowed to stand at room temperature for 7 days for extraction. The extract was filtered with a filter paper to obtain a liquid component, which was then concentrated and dried to prepare 230 g of an ethanol extract of licorice.

As an experimental group, a cocktail preparation drinking water agent (prototype 1) was prepared by dissolving 1.0 g of oleoresin turmeric extract and 100 g of licorice extract in 990 g of sterilized water. A cocktail preparation drinking water agent (prototype-2) was prepared by dissolving 1.0 g of oleoresin turmeric extract, 100 g of licorice extract and 1.0 g of salmon milt extract (purchased from Maruha Nichiro Food Co., Ltd., product name DNA-Na) in 940 g of sterilized water to prepare a composition for the drinking water agent.

Prototype-3 or prototype-4 was prepared by adding 1.0 g of water-soluble curcumin (purchased from K&P NANO) instead of 1.0 g of oleoresin turmeric extract in prototype-1 or prototype-2.

As a control drinking water agent, KW-100 was prepared by dissolving 1.0 g of oleoresin turmeric extract in 1000 g of sterilized water, and KC-100 was prepared by dissolving 100 g of licorice extract in 990 g of sterilized water.

### Experimental Example 1. Confirmation of Deodorizing Effect

In order to examine the deodorizing effect of the drinking water agent prepared in Example 1, 20 mL of the drinking water agent of Example 1 was placed in a 5 L reactor and then sealed. Trimethylamine gas, which is an odor gas, was infused into the reactor while the initial concentration was set to 50 μmol/mol. The experimental temperature was maintained at 25° C. and the humidity at 50%. The concentration of trimethylamine gas was measured at 0 minutes, 30 minutes, 60 minutes, and 120 minutes, respectively. The results are shown in FIG. 1.

As shown in FIG. 1, it was confirmed that trimethylamine and ammonia, which are odor substances, were all removed within 30 minutes according to the treatment of prototype-1. This suggests that the oleoresin turmeric extract and licorice extract have excellent effects of removing the amine compounds.

### Experimental Example 2. Acute Toxicity Experiment

In order to examine the acute toxicity of prototype-2 (KW-100/KC-100/salmon milt extract) prepared in Example 1, the following experiment was conducted.

First, a beagle (10.0 kg to 12.0 kg each), which is a pet, was put in a cage (140 cm×80 cm×80 cm), fed autonomously with a regular diet for 14 days, and bred while maintaining a breeding temperature of 25° C.±2° C. Thereafter, prototype-2 prepared in Example 1 was intraperitoneally or orally administered at a dose of 2000 mg/kg for 7 days (Experimental Group).

The control group was administered with sterile water at the same dose as the experimental group. The experimental model is shown in Table 1 below.

TABLE 1
Animal Experimental Model (beagle) for Acute Toxicity
Evaluation

| | | Subject | | Number of |
|---|---|---|---|---|
| Group | | Female | Male | animals |
| a | Control | 1 | 1 | 2 |
| b | Experimental | 1 | 1 | 2 |
| | Group (oral | | | |
| | administration) | | | |
| c | Experimental | 1 | 1 | 2 |
| | Group | | | |
| | (intraperitoneal | | | |
| | administration) | | | |

| | | | |
|---|---|---|---|
| Number of animals | 3 | 3 | 6 |

As a result, when prototype-2 was administered, the oral administration group (b) and the intraperitoneal administration group (c) showed a high survival rate during the entire 7 days. In addition, as shown in FIG. 2, glomeruli, proximal tubules, and distal tubules showed no pathological lesions as compared with the control group, confirming that prototype-2 was suitable for use as a feed due to low toxicity. The same effect was observed for prototype-3 and prototype-4.

### Experimental Example 3. Evaluation of the Effect of the Drinking Water Agent on the Odor of Animal Excrement

The changes in ammonia level, which is an odor component of urine in experimental animals, were evaluated according to the addition of the drinking water agent of Example 1 in the cage.

Specifically, 10 mL of KW-100, prototype-1 (KW-100/KC-100), and prototype-2 (KW-100/KC-100/salmon milt extract) of Example 1 were given daily to the animal model while maintaining the breeding temperature of 25° C.±2° C. for 10 days. Then, the urine was drawn from the bladder of the experimental animals with a syringe, and the amount of ammonia in the urine (ppm) was analyzed.

Sterilized water was administered to the control group at the same dose. An ammonia reduction rate (%) shows the relative difference in ammonia level between KW-100, prototype-1, and prototype-2, or sterilized water, before and after administration thereof.

As a result, as shown in FIG. 3 and Table 2 below, in the case of the control group, the reduction rate of ammonia contained in the beagle urine was 3%, KW-100 showed the reduction rate of 47.8%, prototype-1 (KW-100/KC-100) showed the reduction rate of 49.5%, and prototype-2 (KW-100/KC-100/salmon milt extract) showed the reduction rate of 85.7%. Prototype-4 showed the same effect as prototype-2.

TABLE 2

| | | | | Prototype-2 |
|---|---|---|---|---|
| | | | | (KW-100/KC- |
| | | | Prototype-1 | 100/salmon |
| | Control | | (KW-100/ | milt |
| Item | Group | KW-100 | KC-100) | extract) |
| Ammonia(N—NH₃) | 3% | 47.8% | 49.5% | 85.7% |
| reduction rate | | | | |

These results suggest that the composition of the present invention effectively removed ammonia contained in the excrement.

Therefore, prototype-2 (KW-100/KC-100/salmon milt extract), which is a composition for a drinking water agent including the oleoresin turmeric extract, licorice extract, and salmon milt extract according to the present invention, could be effectively used for removing amine-based compounds and thus for removing the odor of animal excrement caused by the amine-based compounds.

From the foregoing, a skilled person in the art will be able to understand that the present invention may be embodied in other specific forms without modifying the technical concepts or essential characteristics of the present invention. In this regard, the exemplary embodiments disclosed herein are only for illustrative purposes and should not be construed as limiting the scope of the present invention. On the contrary, the present invention is intended to cover not only the exemplary embodiments but also other embodiments that may be included within the spirit and scope of the present invention as defined by the appended claims, and all modifications and alternatives derived from the equivalents thereof.

1. A composition for removing an amine-based compound, comprising
an oleoresin turmeric extract, a fraction thereof, or water-soluble curcumin;
a licorice extract or a fraction thereof; and
a salmon milt extract
as an active ingredient.

2. The composition for removing an amine-based compound of claim 1, wherein the amine-based compound is trimethylamine or ammonia.

3. The composition for removing an amine-based compound of claim 1, wherein the composition removes the odor caused by an amine-based compound.

4. The composition for removing an amine-based compound of claim 1, wherein the oleoresin turmeric extract or water-soluble curcumin, and the licorice extract are mixed in a weight ratio of 1:20 to 1:200.

5. The composition for removing an amine-based compound of claim 1, wherein the oleoresin turmeric extract is prepared by extracting with a solvent selected from the group consisting of water, an alcohol having 1 to 4 carbon atoms, ethyl acetate, and a mixed solvent thereof.

6. The composition for removing an amine-based compound of claim 1, wherein the licorice extract is prepared by extracting with a solvent selected from the group consisting of water, an alcohol having 1 to 4 carbon atoms, ethyl acetate, and a mixed solvent thereof.

7. A feed composition comprising the composition for removing an amine-based compound of any one of claim 1, or 4 to 6.

8. The feed composition of claim 7, wherein the feed composition removes the odor of animal excrement.

9. The feed composition for claim 7, wherein the feed composition is a drinking water agent.

10. A method for removing the odor of animal excrement, comprising administering the feed composition of claim 7 to an animal.

11. A feed additive composition comprising the composition for removing an amine-based compound of claim 1.

12. A quasi-drug composition comprising the composition for removing an amine-based compound of any one of claim 1, or 4 to 6.
